(19) United States
(12) Patent Application Publication
(10) Pub. No.: US 2025/0135792 A1
(43) Pub. Date: May 1, 2025

(54) INK-JET PRINTING APPARATUS AND INK-JET PRINTING METHOD USING THE SAME

(71) Applicant: Samsung Display Co., LTD., Yongin-si (KR)

(72) Inventors: Hee Jung LEE, Yongin-si (KR); Hong Gi MIN, Yongin-si (KR); Jong Sung KIM, Yongin-si (KR); Sang Jin LEE, Yongin-si (KR); Myung Soo HUH, Yongin-si (KR)

(73) Assignee: Samsung Display Co., LTD., Yongin-si (KR)

(21) Appl. No.: 18/800,309

(22) Filed: Aug. 12, 2024

(30) Foreign Application Priority Data
Oct. 31, 2023 (KR) 10-2023-0148178

(51) Int. Cl. B41J 13/32; B41J 3/28; B41M 5/00

(52) U.S. Cl. CPC B41J 13/32; B41J 3/28; B41M 5/0047

(57) ABSTRACT

An ink-jet printing apparatus includes: a stage on which a substrate including first and second alignment marks is mounted; an ink-jet head part discharging ink; a mark measuring part measuring a first coordinate of each of the first and second alignment marks during a first compensation period, the mark measuring part measuring a second coordinate of the first alignment mark during a second compensation period; and a substrate fixing part holding the substrate. The substrate fixing part performs a first operation to move the substrate such that the first coordinates of the first and second alignment marks in a first direction align with each other during the first compensation period, and performs a second operation to move the substrate according to a result obtained by comparing the second coordinate of the first alignment mark with a reference coordinate of the first alignment mark during the second compensation period.

### CROSS-REFERENCE TO RELATED APPLICATION(S)

This application claims priority to and benefits of Korean patent application No. 10-2023-0148178 under 35 U.S.C. § 119, filed on Oct. 31, 2023, in the Korean Intellectual Property Office, the entire contents of which are incorporated herein by reference.

### BACKGROUND

### 1. Technical Field

Embodiments relate to an ink-jet printing apparatus and an ink-jet printing method using the ink-jet printing apparatus, and more particularly, to an ink-jet printing apparatus for manufacturing a display device and an ink-jet printing method using the ink-jet printing apparatus.

### 2. Description of the Related Art

Recently, as interest in information displays is increased, research and development of display devices have been continuously conducted.

### SUMMARY

Embodiments provide an ink-jet printing apparatus for aligning a substrate, using an alignment mark.

Embodiments also provide an ink-jet printing method using the ink-jet printing apparatus.

However, embodiments are not limited to those set forth herein. The above and other embodiments will become more apparent to one of ordinary skill in the art to which the disclosure pertains by referencing the detailed description of the disclosure given below.

In accordance with an aspect of the disclosure, there is provided an ink-jet printing apparatus including: a stage on which a substrate including a first alignment mark and a second alignment mark is mounted; an ink-jet head part discharging ink; a mark measuring part measuring a first coordinate of each of the first alignment mark and the second alignment mark during a first compensation period, the mark measuring part measuring a second coordinate of the first alignment mark during a second compensation period subsequent to the first compensation period; and a substrate fixing part holding the substrate, wherein the substrate fixing part performs a first operation to move the substrate such that the first coordinate of the first alignment mark in a first direction and the first coordinate of the second alignment mark in the first direction accord (or align) with each other during the first compensation period, and performs a second operation to move the substrate according to a result obtained by comparing the second coordinate of the first alignment mark with a reference coordinate of the first alignment mark during the second compensation period.

The substrate fixing part may move the substrate in case that a difference between the second coordinate of the first alignment mark in the first direction and the reference coordinate of the first alignment mark in the first direction is longer than a reference length.

The substrate fixing part may perform a first operation during the first compensation period in case that a difference between the second coordinate of the first alignment mark in the first direction and the reference coordinate of the first alignment mark in the first direction is longer than a reference length.

The substrate fixing part may include a first substrate moving part and a second substrate moving part which are spaced apart from each other and move the substrate.

The first substrate moving part and the second substrate moving part may rotate the substrate by moving the substrate in different directions.

The reference coordinate may be determined based on a compensation value according to an angle between a virtual line, which passes through the first coordinate of the first alignment mark and the first coordinate of the second alignment mark, and a second direction perpendicular to the first direction.

The reference coordinate may be a coordinate to which the first coordinate of the first alignment mark is adjusted in case that the substrate is moved by the compensation value.

The substrate fixing part may include a first substrate moving part and a second substrate moving part which are spaced apart from each other and move the substrate. The reference coordinate is a coordinate to which the first coordinate of the first alignment mark is adjusted in case that the first substrate moving part moves the substrate by a half of the compensation value in a direction and the second substrate moving part moves the substrate by a half of the compensation value in a direction opposite to the direction.

The compensation value may be determined using a sample substrate including a first sample alignment mark corresponding to the first alignment mark and a second sample alignment mark corresponding to the second alignment mark.

The compensation value may be determined based on a first compensation value according to an angle between a virtual line, which passes through a first coordinate of the first sample alignment mark and a first coordinate of the second sample alignment mark, and the second direction during a first sample compensation period and a second compensation value according to a second coordinate of the first sample alignment mark and a second coordinate of the second sample alignment mark during a second sample compensation period subsequent to the first sample compensation period.

The substrate fixing part may include a first substrate moving part and a second substrate moving part which are spaced apart from each other and move the sample substrate. The first compensation value may be determined using C1=tan (RA)*RD. Here, C1 may be the first compensation value, RA may be the angle between the virtual line, which passes through the first coordinate of the first sample alignment mark and the first coordinate of the second sample alignment mark, and the second direction, and RD may be a distance between the first substrate moving part and the second substrate moving part.

The substrate fixing part may include a first substrate moving part and a second substrate moving part which are spaced apart from each other and move the sample substrate. The second compensation value may be determined using C2=DFF*(RD/(Y′0−Y′1)). Here, C2 may be the second compensation value, DFF may be a difference between the second coordinate of the first sample alignment mark in the first direction and a coordinate to which the first coordinate of the sample first alignment mark in the first direction is adjusted in case that the sample substrate is moved by the first compensation value, RD may be a distance between the first substrate moving part and the second substrate moving part, Y′0 may be the second coordinate of the first sample alignment mark in a second direction intersecting the first direction, and Y′1 may be the second coordinate of the second sample alignment mark in the second direction.

The first alignment mark and the second alignment mark may be adjacent to the substrate fixing part.

In accordance with an aspect of the disclosure, there is provided an ink-jet printing method using an ink-jet printing apparatus discharging ink onto a substrate, the ink-jet printing method including: measuring a first coordinate of each of a first alignment mark and a second alignment mark of the substrate during a first compensation period; moving the substrate such that the first coordinate of the first alignment mark in a first direction and the first coordinate of the second alignment mark in the first direction align with each other during the first compensation period; measuring a second coordinate of the first alignment mark during a second compensation period after moving the substrate during the first compensation period; comparing the second coordinate of the first alignment mark with a reference coordinate of the first alignment mark during the second compensation period; and moving the substrate according to a comparison result.

The moving of the substrate according to the comparison result may include moving the substrate in case that a difference between the second coordinate of the first alignment mark in the first direction and the reference coordinate of the first alignment mark in the first direction is longer than a reference length.

The moving of the substrate according to the comparison result may be performed in case that a difference between the second coordinate of the first alignment mark in the first direction and the reference coordinate of the first alignment mark in the first direction is longer than a reference length.

The reference coordinate may be determined based on a compensation value according to an angle between a virtual line, which passes through the first coordinate of the first alignment mark and the first coordinate of the second alignment mark, and a second direction perpendicular to the first direction.

The reference coordinate may be a coordinate to which the first coordinate of the first alignment mark is adjusted in case that the substrate is moved by the compensation value.

The compensation value may be determined using a sample substrate including a first sample alignment mark corresponding to the first alignment mark and a second sample alignment mark corresponding to the second alignment mark.

The compensation value may be determined based on a first compensation value according to an angle between a virtual line, which passes through a first coordinate of a first sample alignment mark and a first coordinate of a second sample alignment mark, and the second direction during a first sample compensation period and a second compensation value according to a second coordinate of the first sample alignment mark and a second coordinate of the second sample alignment mark during a second sample compensation period subsequent to the first sample compensation period.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a schematic view illustrating an ink-jet printing apparatus in accordance with embodiments.

FIG. 2 is a schematic plan view illustrating the ink-jet printing apparatus shown in FIG. 1.

FIG. 3 is a schematic view illustrating an example of a case where the ink-jet printing apparatus shown in FIG. 1 moves a substrate during a first compensation period.

FIG. 4 is a schematic view illustrating an example of a case where the ink-jet printing apparatus shown in FIG. 1 does not move the substrate during a second compensation period.

FIG. 5 is a schematic view illustrating an example in which the ink-jet printing apparatus shown in FIG. 1 moves the substrate during the second compensation period.

FIG. 6 is a schematic view illustrating an example in which a first compensation value is determined during a first sample compensation period.

FIG. 7 is a schematic view illustrating an example in which a second compensation value is determined during a second sample compensation period.

FIG. 8 is a flowchart illustrating an ink-jet printing method in accordance with embodiments.

### DETAILED DESCRIPTION OF THE EMBODIMENTS

In the following description, for the purposes of explanation, numerous specific details are set forth in order to provide a thorough understanding of various embodiments or implementations of the invention. As used herein, “embodiments” and “implementations” are interchangeable words that are non-limiting examples of devices or methods disclosed herein. It is apparent, however, that various embodiments may be practiced without these specific details or with one or more equivalent arrangements. Here, various embodiments do not have to be exclusive nor limit the disclosure. For example, specific shapes, configurations, and characteristics of an embodiment may be used or implemented in another embodiment.

Unless otherwise specified, the illustrated embodiments are to be understood as providing features of the invention. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the scope of the invention.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element or a layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. For the purposes of this disclosure, “at least one of A and B” may be understood to mean A only, B only, or any combination of A and B. Also, “at least one of X, Y, and Z” and “at least one selected from the group consisting of X, Y, and Z” may be construed as X only, Y only, Z only, or any combination of two or more of X, Y, and Z. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one element's relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the term “below” can encompass both an orientation of above and below. Furthermore, the apparatus may be otherwise oriented (e.g., rotated 90 degrees or at other orientations), and, as such, the spatially relative descriptors used herein should be interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the invention. Further, the blocks, units, and/or modules of some embodiments may be physically combined into more complex blocks, units, and/or modules without departing from the scope of the invention.

For example, the embodiments of the disclosure are described here with reference to schematic diagrams of embodiments (and an intermediate structure), so that changes in a shape as shown due to, for example, manufacturing technology and/or a tolerance may be expected. Therefore, the embodiments shall not be limited to the specific shapes of a region shown here, but include shape deviations caused by, for example, the manufacturing technology. The regions shown in the drawings are schematic in nature, and the shapes thereof do not represent the actual shapes of the regions of the device, and do not limit the scope of the disclosure.

Hereinafter, the disclosure will be described in more detail with reference to the accompanying drawings.

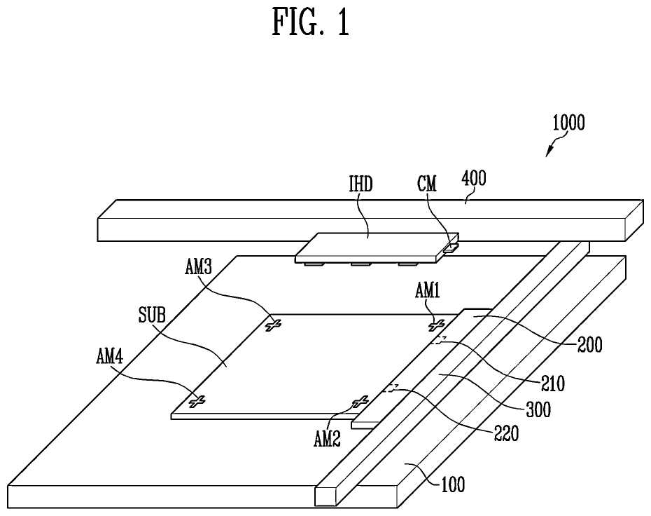

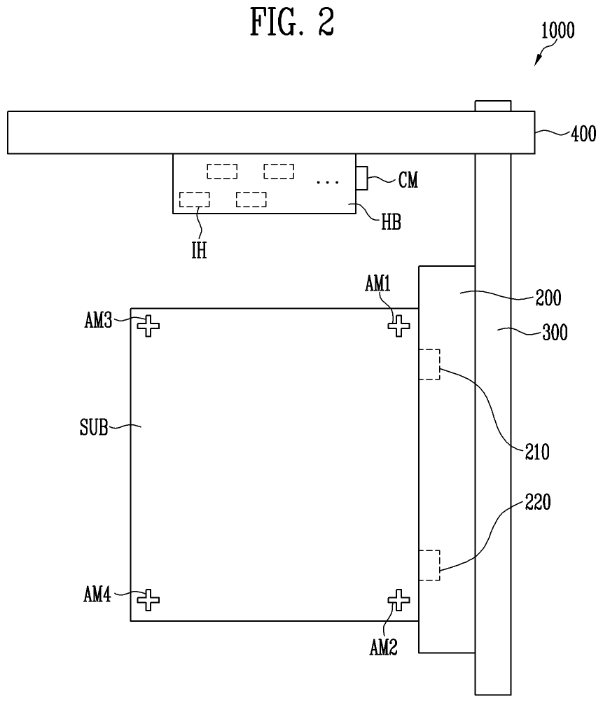

FIG. 1 is a schematic view illustrating an ink-jet printing apparatus 1000 in accordance with embodiments. FIG. 2 is a schematic plan view illustrating the ink-jet printing apparatus 1000 shown in FIG. 1.

In FIG. 2, a stage 100 is omitted for convenience of description.

Referring to FIGS. 1 and 2, the ink-jet printing apparatus 1000 may discharge (or inject) ink onto a substrate SUB. The ink may include at least one light emitting element, and the light emitting element may be formed on the substrate SUB.

The ink-jet printing apparatus 1000 may include the stage 100, a substrate fixing part 200, a first unit supporting part 300, an ink-jet head part IHD, a second unit supporting part 400, and a mark measuring part CM.

The stage 100 may include an area in which the substrate SUB is disposed. The substrate SUB may be loaded or unloaded onto or from the stage 100.

In an embodiment, the stage 100 may be moved along a rail. In an embodiment, a probe may be disposed on the stage 100. The probe may generate an electric field on the substrate SUB.

The substrate fixing part 200 may fix (or hold) the substrate SUB. For example, the substrate fixing part 200 may fix (or hold) the substrate SUB not to move during ink-jet printing.

The substrate fixing part 200 may align the substrate SUB. The substrate fixing part 200 may include a first substrate moving part 210 and a second substrate moving part 220 which are spaced apart from each other and move the substrate SUB. For example, each of the first substrate moving part 210 and the second substrate moving part 220 may be an actuator.

In an embodiment, the first substrate moving part 210 and the second substrate moving part 220 may rotate the substrate SUB by moving the substrate SUB in different directions. For example, in case that the first substrate moving part 210 pulls the substrate SUB and the second substrate moving part 220 pushes the substrate SUB, the substrate SUB may be rotated in a clockwise direction. For example, in case that the first substrate moving part 210 pushes the substrate SUB and the second substrate moving part 220 pulls the substrate SUB, the substrate SUB may be rotated in a counterclockwise direction.

The first unit supporting part 300 may be connected (or coupled) to the substrate fixing part 200. In an embodiment, the substrate fixing part 200 may be moved along the first unit supporting part 300.

The second unit supporting part 400 may be connected (or coupled) to the ink-jet head part IHD. The ink-jet head part IHD may be moved along the second unit supporting part 400. The ink-jet head part IHD may discharge (or inject) the ink including the light emitting element onto the substrate SUB.

The ink-jet head part IHD may include a head base HB and an ink-jet head IH. The head base HB may be connected to the second unit supporting part 400, to form an area in which the ink-jet head IH is disposed. The head base HB may extend in a direction, to be spaced apart from the stage 100. In an embodiment, the head base HB may move the ink-jet head IH.

The ink-jet head IH may be disposed on a surface of the head base HB. For example, the ink-jet head IH may be provided in plurality, to be disposed on a bottom surface (or lower surface) of the head base HB, which is spaced apart from each other. The number of ink-jet heads IH is not limited to a specific example.

The ink-jet head IH may supply the ink onto the substrate SUB. For example, the ink-jet head IH may include a nozzle part through which the ink is discharged (or injected), thereby discharging the ink to the outside.

The mark measuring part CM may measure coordinates of alignment marks AM1, AM2, AM3, and AM4. For example, the mark measuring part CM may be a camera. However, embodiments are not limited thereto as long as the mark measuring part CM is any one capable of generating image data by photographing the alignment marks AM1, AM2, AM3, and AM4. Also, embodiments are not limited to the number, shape, and positions of the alignment marks AM1, AM2, AM3, and AM4.

In an embodiment, the mark measuring part CM may be connected (or coupled) to the ink-jet head part IHD. For example, a coordinate may be configured with an X-axis coordinate and a Y-axis coordinate, and an X-axis and a Y-axis may be set with respect to the ink-jet head part IHD. For example, the X-axis may be a direction parallel to the ink-jet head part IHD, and the Y-axis may be a direction perpendicular to the ink-jet head part IHD. Since the ink is discharged (or injected) from the ink-jet head part IHD, the X-axis and the Y-axis are set with respect to the ink-jet head part IHD, so that the alignment accuracy of the substrate SUB may be improved. However, the mark measuring part CM may not be connected to the ink-jet head part IHD.

Hereinafter, for convenience of description, an X-axis direction is a designated as a first direction X, a Y-axis direction is designated as a second direction Y, the X-axis coordinate is designated as a coordinate of the first direction X, and the Y-axis coordinate is designated as a coordinate of the second direction Y.

In an embodiment, the ink-jet printing apparatus 1000 may include a control part. For example, the control part may receive image data including the coordinates of the alignment marks AM1, AM2, AM3, and AM4 from the mark measuring part CM, and control the substrate fixing part 200, the first unit supporting part 300, and the second unit supporting part 400.

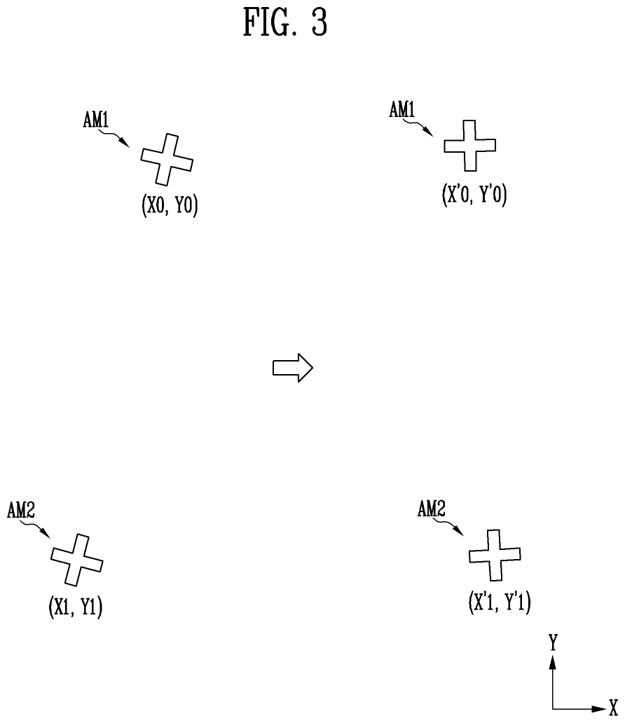

FIG. 3 is a schematic view illustrating an example in which the ink-jet printing apparatus 1000 shown in FIG. 1 moves a substrate during a first compensation period.

Referring to FIGS. 1 to 3, the substrate SUB may include first to fourth alignment marks AM1, AM2, AM3, and AM4. In an embodiment, alignment of the substrate SUB may be performed through the first alignment mark AM1 and the second alignment mark AM2. For example, the first alignment mark AM1 and the second alignment mark AM2 may be alignment marks close to the substrate fixing part 200. The substrate fixing part 200 may align the substrate SUB through the alignment marks close to the substrate fixing part 200, so that the alignment accuracy of the substrate SUB may be improved. However, embodiments are not limited to the number and kind of alignment marks used therein.

The mark measuring part CM may measure a first coordinate of each of the first alignment mark AM1 and the second alignment mark AM2 during the first compensation period. The first coordinate may be a coordinate before the substrate SUB is moved during the first compensation period, the first coordinate of the first alignment mark AM1 may be (X0, Y0), and the first coordinate of the second alignment mark AM2 is (X1, Y1). For example, after the substrate SUB is moved during the first compensation period, a coordinate of the first alignment mark AM1 may be (X′0, Y′0), and a coordinate of the second alignment mark AM2 may be (X′1, Y′1).

The ink-jet printing apparatus 1000 may control (or adjust) the first coordinates of the first alignment mark AM1 and the second alignment mark AM2 in the first direction X to accord (or align) with each other, so that the substrate SUB may be accurately aligned. The substrate fixing part 200 may move the substrate SUB such that the first coordinate of the first alignment mark AM1 in the first direction X and the first coordinate of the second alignment mark AM2 in the first direction X accord (or align) with each other (e.g., in the second direction Y) during the first compensation period.

For example, the coordinate of the first alignment mark AM1 may be changed from (X0, Y0) to (X′0, Y′0). For example, the coordinate of the second alignment mark AM2 may be changed from (X1, Y1) to (X′1, Y′1).

However, the coordinate of the first alignment mark AM1 in the first direction X and the coordinate of the second alignment mark AM2 in the first direction X may not accurately accord (or align) with each other (e.g., in the second direction Y) due to a driving error of the first and second substrate moving parts 210 and 220 and a measurement error of the mark measuring part CM. Therefore, the ink-jet printing apparatus 1000 may check whether a coordinate shifted during a second compensation period is within an allowable (or acceptable) range.

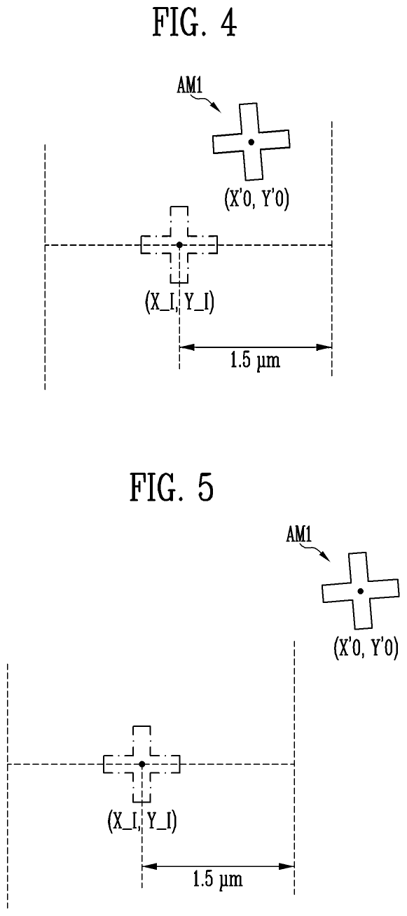

FIG. 4 is a schematic view illustrating an example of a case where the ink-jet printing apparatus 1000 shown in FIG. 1 does not move the substrate SUB during the second compensation period. FIG. 5 is a schematic view illustrating an example of a case where the ink-jet printing apparatus 1000 shown in FIG. 1 moves the substrate SUB during the second compensation period.

Referring to FIGS. 1, 2, 4, and 5, the mark measuring part CM may measure a second coordinate of the first alignment mark AM1 during a second compensation period subsequent to a first compensation period. The second coordinate may be a coordinate before the substrate SUB is moved during the second compensation period and may be a coordinate after the substrate SUB is moved during the first compensation period. The second coordinate of the first alignment mark AM1 may be (X′0, Y′0). For example, a reference coordinate of the first alignment mark AM1 may be (X_1, Y_1).

However, an alignment mark used during the second compensation period may not be the first alignment mark AM1.

The ink-jet printing apparatus 1000 may determine whether the substrate SUB has been moved by comparing the second coordinate of the first alignment mark AM1 with the reference coordinate of the first alignment mark AM1. The substrate fixing part 200 may move the substrate SUB according to a result obtained by comparing the second coordinate of the first alignment mark AM1 with the reference coordinate of the first alignment mark AM1 during the second compensation period.

In an embodiment, in case that a difference between the second coordinate of the first alignment mark AM1 in the first direction X and the reference coordinate of the first alignment mark AM1 in the first direction X is longer than a reference length, the substrate fixing part 200 may move the substrate SUB. For example, as shown in FIG. 4, in case that the reference length is about 1.5 μm, and the difference is smaller than about 1.5 μm, the ink-jet printing apparatus 1000 may discharge (or inject) the ink without moving the substrate SUB. For example, as shown in FIG. 5, in case that the reference length is about 1.5 μm, and the difference is greater than about 1.5 μm, the ink-jet printing apparatus 1000 may move the substrate and then discharge (or inject) the ink.

In an embodiment, in case that the difference between the second coordinate of the first alignment mark AM1 in the first direction X and the reference coordinate of the first alignment mark AM1 in the first direction X is longer than the reference length, the substrate fixing part 200 may perform the operation during the first compensation period. For example, the ink-jet printing apparatus 1000 may re-measure coordinates of the first alignment mark AM1 and the second alignment mark AM2, and re-move the substrate SUB.

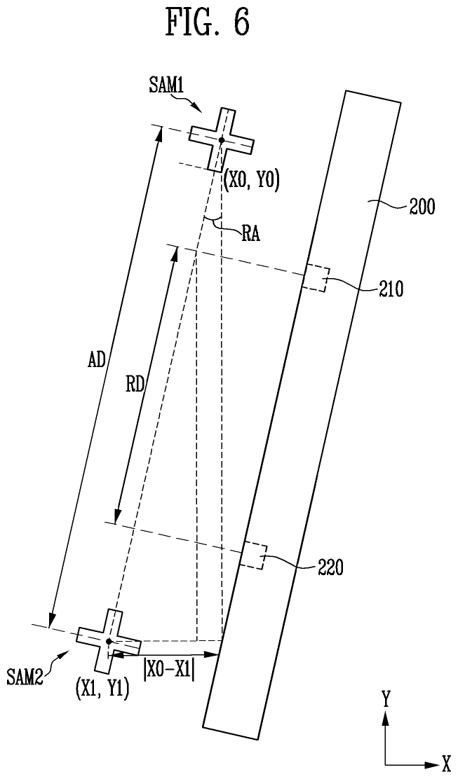

The reference coordinate of the first alignment mark AM1 may be a coordinate at which the first alignment mark AM1 is accurately positioned during the first compensation period. In an embodiment, the reference coordinate may be determined based on a compensation value according to an angle (e.g., an angle corresponding to an angle RA of a sample substrate shown in FIG. 6) between a virtual line, which passes through the first coordinate of the first alignment mark AM1 and the first coordinate of the second alignment mark AM2, and the second direction Y. The angle RA may represent a degree to which the substrate SUB is shifted with respect to the first direction X. For example, in case that the first direction X is set with respect to the ink-jet head part IHD, the angle RA may represent a degree to which the substrate SUB is shifted with respect to the ink-jet head part IHD.

The reference coordinate may be a coordinate at which the first coordinate of the first alignment mark AM1 moves in case that the substrate SUB is moved by the compensation value. For example, the reference coordinate may be a coordinate at which the first coordinate of the first alignment mark AM1 is accurately moved. For example, the reference coordinate may be a coordinate at which the first coordinate of the first alignment mark AM1 in case that the first substrate moving part 210 moves the substrate SUB by a half of the compensation value in a direction and the second substrate moving part 220 moves the substrate SUB by a half of the compensation value in a direction opposite to the direction. For example, a case where the compensation value is about 1 μm is assumed. The reference coordinate may be a coordinate at which the first coordinate of the first alignment mark AM1 moves in case that the first substrate moving part 210 pulls the substrate SUB by about 0.5 μm and the second substrate moving part 220 pushes the substrate by about 0.5 μm. The reference coordinate may be a coordinate calculated mathematically, by the ink-jet printing apparatus 1000, by a computer device, or the like.

The compensation value will be described in detail later.

For example, the ink-jet printing apparatus 1000 may not use two alignment marks during the second compensation period identically to the first compensation period, but uses an alignment mark (e.g., single alignment mark). Thus, the tact time (or manufacturing time) of a display device including the substrate SUB may be decreased.

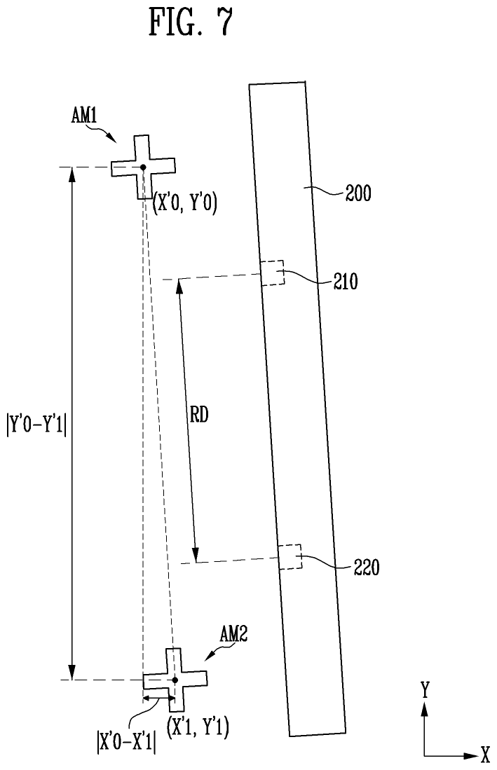

FIG. 6 is a schematic view illustrating an example in which a first compensation value is determined during a first sample compensation period. FIG. 7 is a schematic view illustrating an example in which a second compensation value is determined during a second sample compensation period.

Referring to FIGS. 1, 2, 6, and 7, a compensation value may be determined using a sample substrate including a first sample alignment mark SAM1 corresponding to the first alignment mark AM1 and a second sample alignment mark SAM2 corresponding to the second alignment mark AM2.

The ink-jet printing apparatus 1000 may align the substrate, based on the compensation value determined using the sample substrate. The sample substrate may be a substrate for determining the compensation value, and may have the same structure as the substrate SUB. However, the sample substrate and the substrate SUB are not different from each other. For example, the compensation value may not be determined using a single sample substrate. A plurality of compensation values may be determined using a plurality of sample substrates (or one sample substrate), and one compensation value (e.g., an average value) for alignment of the substrate SUB may be determined based on the compensation values.

The compensation value may be determined based on a first compensation value according to an angle RA between a virtual line, which passes through a first coordinate of the first sample alignment mark SAM1 and a first coordinate of the second sample alignment mark SAM2, and the second direction Y during a first sample compensation period and a second compensation value according to a second coordinate of the first sample alignment mark SAM1 and a second coordinate of the second sample alignment mark SAM2 during a second sample compensation period subsequent to the first sample compensation period. For example, in case that compensation directions of the first sample alignment period and the second sample compensation period are the same, the compensation value may be a sum of the first compensation value and the second compensation value. For example, in case that both the first coordinate and the second coordinate of the first sample alignment mark SAM1 are to be move in the first direction X, the compensation directions of the first sample alignment period and the second sample compensation period may be the same. For example, in case that the compensation directions of the first sample alignment period and the second sample compensation period are different from each other, the compensation value may be a difference between the first compensation value and the second compensation value. For example, in case that the first coordinate of the first sample alignment mark SAM1 is to move in the first direction X and the second coordinate of the first sample alignment mark SAM1 is to move in a direction opposite to the first direction X, the compensation directions of the first sample alignment period and the second sample compensation period may be different from each other.

The mark measuring part CM may measure a first coordinate of each of the first sample alignment mark SAM1 and the second sample alignment mark SAM2 during the first sample compensation period. The first coordinate may be a coordinate before the sample substrate is moved during the first sample compensation period, the first coordinate of the first sample alignment mark SAM1 may be (X0, Y0), and the first coordinate of the second sample alignment mark SAM2 may be (X1, Y1).

The first compensation value may be a compensation value for adjusting the first coordinate of the first sample alignment mark SAM1 in the first direction X and the first coordinate of the second sample alignment mark SAM2 in the first direction X to accord (or align) with each other. For example, the first compensation value may be determined according to the angle RA (e.g., a degree to which the sample substrate is shifted with respect to the first direction X).

For example, the first compensation value may be determined using Expression 1.

$$C 1 = tan ( RA ) * RD \qquad Expression 1$$

Here, C1 may be the first compensation value, RA may be the angle between the virtual line, which passes through the first coordinate of the first sample alignment mark SAM1 and the first coordinate of the second sample alignment mark SAM2, and the second direction Y, and RD may be a distance between the first substrate moving part 210 and the second substrate moving part 220. Since the sample substrate and the substrate SUB are moved by the first substrate moving part 210 and the second substrate moving part 220 according to the first compensation value, the first compensation value may be calculated from the distance RD between the first substrate moving part 210 and the second substrate moving part 220.

In an embodiment, the angle RA may be determined using Expression 2.

$$arc tan ( \vert X 0 - X 1 \vert / AD ) \qquad Expression 2$$

Here, X0 may be the first coordinate of the first sample alignment mark SAM1 in the first direction X, X1 may be the first coordinate of the second sample alignment mark SAM2 in the first direction X, and AD may be a distance between the first sample alignment mark SAM1 and the second sample alignment mark SAM2. Since an angle between the first coordinate of the first sample alignment mark SAM1 and the first coordinate of the second sample alignment mark SAM2 is small, and the distance between the first sample alignment mark SAM1 and the second sample alignment mark SAM2 and a difference between a first coordinate of the first sample alignment mark SAM1 in the second direction Y and a first coordinate of the second sample alignment mark SAM2 in the second direction Y may be substantially similar to each other, an “arc tangent” trigonometric function may be used to calculate the angle RA. However, embodiments are not limited thereto, and an “arc sine” trigonometric function may be used.

The substrate fixing part 200 may move the sample substrate such that the first coordinate of the first sample alignment mark SAM1 in the first direction X and the first coordinate of the second sample alignment mark SAM2 in the first direction X accord (or align) with each other during the first sample compensation period.

The mark measuring part CM may measure a second coordinate of the first sample alignment mark SAM1 and measure a second coordinate of the second sample alignment mark SAM2 during the second sample compensation period. The second coordinate may be a coordinate before the sample substrate is moved during the second sample compensation period and may be a coordinate after the sample substrate is moved during the first sample compensation period. The second coordinate of the first sample alignment mark SAM1 may be (X′0, Y′0), and the second coordinate of the second sample alignment mark SAM2 is (X′1, Y′1).

For example, the coordinate of the first sample alignment mark SAM1 may be changed from (X0, Y0) to (X′0, Y′0). For example, the coordinate of the second sample alignment mark SAM2 may be changed from (X1, Y1) to (X′1, Y′1).

However, the first coordinate of the first sample alignment mark SAM1 in the first direction X and the first coordinate of the second sample alignment mark SAM2 in the first direction X may not accurately accord (or align) with each other due to a driving error of the first and second substrate moving parts 210 and 220 and a measurement error of the mark measuring part CM. For example, compensation during the first sample compensation period and the first compensation period, which is performed by the ink-jet printing apparatus 1000, may be shifted within a range having a constant tendency. Thus, the compensation value may be determined based on the second compensation value determined according to a degree to which the sample substrate is shifted due to the movement during the first sample compensation period, so that the ink-jet printing apparatus 1000 may perform compensation, using an alignment mark (e.g., single mask) during the second compensation period.

The second compensation value may be a compensation value for adjusting the second coordinate of the first sample alignment mark SAM1 in the first direction X and the second coordinate of the second sample alignment mark SAM2 in the first direction X to accord (or align) with each other during the second sample compensation period. The second compensation value may be determined according to a difference between an accurate second coordinate of the first sample alignment mark SAM moved by the first compensation value in the first direction X and the measured second coordinate of the first sample alignment mark SAM1 in the first direction X.

For example, the second compensation value may be determined using Expression 3.

$$C2 = DFF * ( RD / {Y}^{′} 0 - {Y}^{′} 1 ) ) \qquad Expression 3$$

Here, C2 may be the second compensation value, DFF may be a difference between the second coordinate of the first sample alignment mark SAM1 in the first direction X and a coordinate to which the first coordinate of the first sample alignment mark SAM1 in the first direction X moves (or is adjusted) in case that the sample substrate is moved by the first compensation value, RD may be the distance between the first substrate moving part 210 and the second substrate moving part 220, Y′0 may be a second coordinate of the first sample alignment mark SAM1 in the second direction Y, and Y′1 may be a second coordinate of the second sample alignment mark SAM2 in the second direction Y.

In case that the sample substrate is moved by the first compensation value, the coordinate to which the first coordinate of the first sample alignment mark SAM1 in the first direction X moves (or is adjusted) may be a coordinate, which is calculated mathematically, by the ink-jet printing apparatus 1000, by a computer device, or the like. For example, since the sample substrate and the substrate SUB are moved by the first substrate moving part 210 and the second substrate moving part 220 according to the second compensation value, the second compensation value may be calculated from the distance between the first substrate moving part 210 and the second substrate moving part 220.

For example, the ink-jet printing apparatus 1000 may determine a reference coordinate moved in case that the substrate is shifted at a specific angle through the sample substrate (e.g., an accurately moved coordinate), and determine whether the substrate SUB has been aligned by comparing the second coordinate of the first alignment mark AM1 with the reference coordinate.

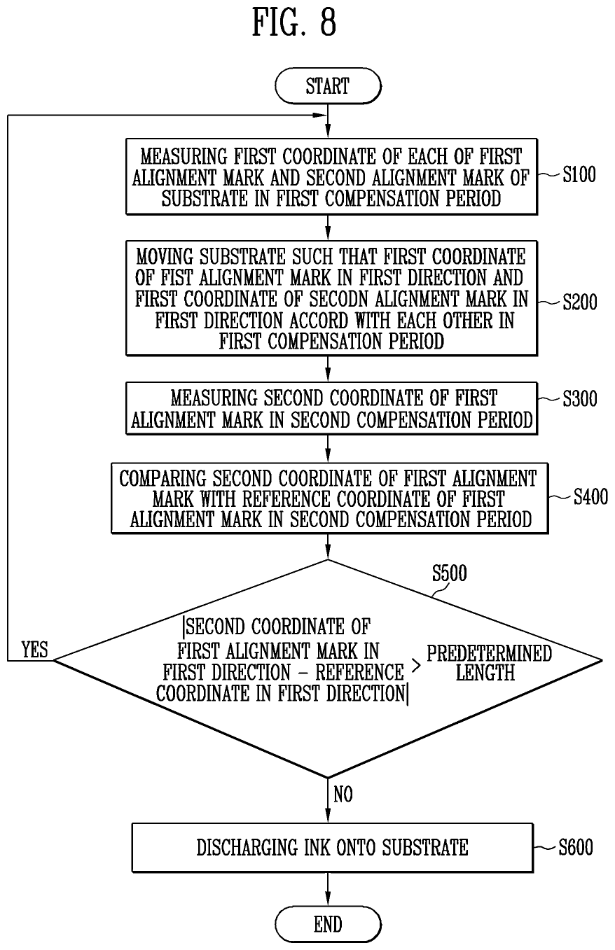

FIG. 8 is a flowchart illustrating an ink-jet printing method in accordance with embodiments.

Referring to FIG. 8, in the ink-jet printing method, a first coordinate of each of a first alignment mark AM1 and a second alignment mark AM2 of a substrate SUB may be measured during a first compensation period (S100), the substrate SUB may be moved such that the first coordinate of the first alignment mark AM1 in the first direction and the first coordinate of the second alignment mark AM2 in the first direction may accord (or align) with each other during the first compensation period (S200), a second coordinate of the first alignment mark AM1 may be measured during a second compensation period (S300), the second coordinate of the first alignment mark AM1 may be compared with a reference coordinate of the first alignment mark AM1 during the second compensation period (S400), the substrate SUB may be moved according to a comparison result (S500), and ink may be discharged (or injected) onto the substrate SUB (S600).

In an embodiment, in the ink-jet printing method, in case that a difference between the second coordinate of the first alignment mark AM1 in the first direction and the reference coordinate of the first alignment mark AM1 in the first direction is longer than a reference length, the substrate SUB may be moved. In an embodiment, in the ink-jet printing method, in case that the difference between the second coordinate of the first alignment mark AM1 in the first direction and the reference coordinate of the first alignment mark AM1 in the first direction is longer than the reference length, an operation of the first compensation period may be performed.

In the ink-jet printing apparatus 1000 in accordance with the embodiments, as a substrate SUB is aligned plural times, the substrate SUB may be accurately aligned.

In the ink-jet printing apparatus 1000 in accordance with the embodiments, one an alignment mark (e.g., single alignment mark) may be used during the second compensation period, so that the tact time of a display device may be decreased.

In concluding the detailed description, those skilled in the art will appreciate that many variations and modifications may be made to the embodiments without substantially departing from the principles and spirit and scope of the disclosure. Therefore, the disclosed embodiments are used in a generic and descriptive sense only and not for purposes of limitation.

What is claimed is:

1. An ink-jet printing apparatus comprising:
a stage on which a substrate including a first alignment mark and a second alignment mark is mounted;
an ink-jet head part discharging ink;
a mark measuring part measuring a first coordinate of each of the first alignment mark and the second alignment mark during a first compensation period, the mark measuring part measuring a second coordinate of the first alignment mark during a second compensation period subsequent to the first compensation period; and
a substrate fixing part holding the substrate,
wherein the substrate fixing part performs a first operation to move the substrate such that the first coordinate of the first alignment mark in a first direction and the first coordinate of the second alignment mark in the first direction align with each other during the first compensation period, and performs a second operation to move the substrate according to a result obtained by comparing the second coordinate of the first alignment mark with a reference coordinate of the first alignment mark during the second compensation period.

2. The ink-jet printing apparatus of claim 1, wherein the substrate fixing part perform the second operation to move the substrate in case that a difference between the second coordinate of the first alignment mark in the first direction and the reference coordinate of the first alignment mark in the first direction is longer than a reference length.

3. The ink-jet printing apparatus of claim 1, wherein the substrate fixing part performs the first operation during the first compensation period in case that a difference between the second coordinate of the first alignment mark in the first direction and the reference coordinate of the first alignment mark in the first direction is longer than a reference length.

4. The ink-jet printing apparatus of claim 1, wherein the substrate fixing part includes a first substrate moving part and a second substrate moving part which are spaced apart from each other and move the substrate.

5. The ink-jet printing apparatus of claim 4, wherein the first substrate moving part and the second substrate moving part rotate the substrate by moving the substrate in different directions.

6. The ink-jet printing apparatus of claim 1, wherein the reference coordinate is determined based on a compensation value according to an angle between a virtual line, which passes through the first coordinate of the first alignment mark and the first coordinate of the second alignment mark, and a second direction perpendicular to the first direction.

7. The ink-jet printing apparatus of claim 6, wherein the reference coordinate is a coordinate to which the first coordinate of the first alignment mark is adjusted in case that the substrate is moved by the compensation value.

8. The ink-jet printing apparatus of claim 7, wherein
the substrate fixing part includes a first substrate moving part and a second substrate moving part which are spaced apart from each other and move the substrate, and
the reference coordinate is a coordinate to which the first coordinate of the first alignment mark is adjusted in case that the first substrate moving part moves the substrate by a half of the compensation value in a direction and the second substrate moving part moves the substrate by a half of the compensation value in a direction opposite to the direction.

9. The ink-jet printing apparatus of claim 6, wherein the compensation value is determined using a sample substrate including a first sample alignment mark corresponding to the first alignment mark and a second sample alignment mark corresponding to the second alignment mark.

10. The ink-jet printing apparatus of claim 9, wherein the compensation value is determined based on a first compensation value according to an angle between a virtual line, which passes through a first coordinate of the first sample alignment mark and a first coordinate of the second sample alignment mark, and the second direction during a first sample compensation period and a second compensation value according to a second coordinate of the first sample alignment mark and a second coordinate of the second sample alignment mark during a second sample compensation period subsequent to the first sample compensation period.

11. The ink-jet printing apparatus of claim 10, wherein
the substrate fixing part includes a first substrate moving part and a second substrate moving part which are spaced apart from each other and move the sample substrate,
the first compensation value is determined using:
C1=tan(RA)*RD, and
C1 is the first compensation value, RA is the angle between the virtual line, which passes through the first coordinate of the first sample alignment mark and the first coordinate of the second sample alignment mark, and the second direction, and RD is a distance between the first substrate moving part and the second substrate moving part.

12. The ink-jet printing apparatus of claim 10, wherein
the substrate fixing part includes a first substrate moving part and a second substrate moving part which are spaced apart from each other and move the sample substrate,
the second compensation value is determined using:
C2=DFF*(RD/(Y′0−Y′1)), and
C2 is the second compensation value, DFF is a difference between the second coordinate of the first sample alignment mark in the first direction and a coordinate to which the first coordinate of the sample first alignment mark in the first direction is adjusted in case that the sample substrate is moved by the first compensation value, RD is a distance between the first substrate moving part and the second substrate moving part, Y′0 is the second coordinate of the first sample alignment mark in a second direction perpendicular the first direction, and Y′1 is the second coordinate of the second sample alignment mark in the second direction.

13. The ink-jet printing apparatus of claim 1, wherein the first alignment mark and the second alignment mark are adjacent to the substrate fixing part.

14. An ink-jet printing method using an ink-jet printing apparatus discharging ink onto a substrate, the ink-jet printing method comprising:
measuring a first coordinate of each of a first alignment mark and a second alignment mark of the substrate during a first compensation period;
moving the substrate such that the first coordinate of the first alignment mark in a first direction and the first coordinate of the second alignment mark in the first direction align with each other during the first compensation period;
measuring a second coordinate of the first alignment mark during a second compensation period after moving the substrate during the first compensation period;
comparing the second coordinate of the first alignment mark with a reference coordinate of the first alignment mark during the second compensation period; and
moving the substrate according to a comparison result.

15. The ink-jet printing method of claim 14, wherein the moving of the substrate according to the comparison result includes moving the substrate in case that a difference between the second coordinate of the first alignment mark in the first direction and the reference coordinate of the first alignment mark in the first direction is longer than a reference length.

16. The ink-jet printing method of claim 14, wherein the moving of the substrate according to the comparison result is performed in case that a difference between the second coordinate of the first alignment mark in the first direction and the reference coordinate of the first alignment mark in the first direction is longer than a reference length.

17. The ink-jet printing method of claim 14, wherein the reference coordinate is determined based on a compensation value according to an angle between a virtual line, which passes through the first coordinate of the first alignment mark and the first coordinate of the second alignment mark, and a second direction perpendicular to the first direction.

18. The ink-jet printing method of claim 17, wherein the reference coordinate is a coordinate to which the first coordinate of the first alignment mark is adjusted in case that the substrate is moved by the compensation value.

19. The ink-jet printing method of claim 17, wherein the compensation value is determined using a sample substrate including a first sample alignment mark corresponding to the first alignment mark and a second sample alignment mark corresponding to the second alignment mark.

20. The ink-jet printing method of claim 17, wherein the compensation value is determined based on a first compensation value according to an angle between a virtual line, which passes through a first coordinate of a first sample alignment mark and a first coordinate of a second sample alignment mark, and the second direction during a first sample compensation period and a second compensation value according to a second coordinate of the first sample alignment mark and a second coordinate of the second sample alignment mark during a second sample compensation period subsequent to the first sample compensation period.
